(19) United States
(12) Patent Application Publication
(10) Pub. No.: US 2023/0339724 A1
(43) Pub. Date: Oct. 26, 2023

(54) ELEVATOR CAR POSITION DETECTION

(71) Applicant: Otis Elevator Company, Farmington, CT (US)

(72) Inventor: Nishit Oza, North Andover, WA (US)

(21) Appl. No.: 17/728,346

(22) Filed: Apr. 25, 2022

(51) Int. Cl. B66B 1/34

(52) U.S. Cl. CPC B66B 1/3492; B66B 1/3461

(57) ABSTRACT

An elevator car position determining system includes a tag mounted to an elevator car, the elevator car configured to travel in a hoistway; at least one anchor mounted in the hoistway; a gateway in communication with the tag; wherein the tag is configured to send a poll signal; wherein the at least one anchor is configured to generate a reply signal in response to the poll signal; wherein the tag is configured to determine a position of the elevator car in the hoistway in response to a time of flight of the poll signal to the at least one anchor and a time of flight of the reply signal to the tag.

### BACKGROUND

The embodiments described herein relate generally to elevator systems, and more particularly, to determining the position of an elevator car without relying upon access to an elevator controller.

It is desirable to know the location of an elevator car in an elevator system, in real time, without having to rely on information provided by the elevator controller. Typically, the elevator controller knows the location of the elevator car, by using positioning systems in the elevator system. There are, however, situations where the elevator controller is not accessible. For example, interfacing with the elevator controller may require proprietary credentials or customized tools, or the company maintaining and servicing the elevator is different from the company that manufactured the elevator controller. In such cases, it may not be practical to obtain the elevator car position from the controller.

### BRIEF SUMMARY

According to an embodiment, an elevator car position determining system includes a tag mounted to an elevator car, the elevator car configured to travel in a hoistway; at least one anchor mounted in the hoistway; a gateway in communication with the tag; wherein the tag is configured to send a poll signal; wherein the at least one anchor is configured to generate a reply signal in response to the poll signal; wherein the tag is configured to determine a position of the elevator car in the hoistway in response to a time of flight of the poll signal to the at least one anchor and a time of flight of the reply signal to the tag.

In addition to one or more of the features described herein, or as an alternative, further embodiments may include wherein the tag is configured to send the position of the elevator car to the gateway.

In addition to one or more of the features described herein, or as an alternative, further embodiments may include wherein the tag is configured to send the position of the elevator car to a mobile device.

In addition to one or more of the features described herein, or as an alternative, further embodiments may include wherein the gateway is in communication with a remote system.

In addition to one or more of the features described herein, or as an alternative, further embodiments may include wherein the gateway is in communication with a mobile device.

In addition to one or more of the features described herein, or as an alternative, further embodiments may include wherein the at least one anchor includes a plurality of anchors, each of the plurality of anchors mounted at a different location in the hoistway.

In addition to one or more of the features described herein, or as an alternative, further embodiments may include wherein the tag is configured to receive the reply signal from each of the plurality of anchors; wherein the tag is configured to determine the position of the elevator car in response to the reply signal from each of the plurality of anchors.

In addition to one or more of the features described herein, or as an alternative, further embodiments may include wherein the tag is configured to eliminate a distance calculation to an anchor of the plurality of anchors in determining the position of the elevator car.

According to another embodiment, a method of determining a position of an elevator car includes installing a tag on an elevator car, the elevator car configured to travel in a hoistway; installing at least one anchor in the hoistway; installing a gateway, the gateway in communication with the tag; sending a poll signal from the tag; generating a reply signal at the anchor in response to the poll signal; determining, by the tag, the position of the elevator car in the hoistway in response to a time of flight of the poll signal to the at least one anchor and a time of flight of the reply signal to the tag.

In addition to one or more of the features described herein, or as an alternative, further embodiments of the method may include sending the position of the elevator car to the gateway.

In addition to one or more of the features described herein, or as an alternative, further embodiments of the method may include sending the position of the elevator car to a mobile device.

In addition to one or more of the features described herein, or as an alternative, further embodiments of the method may include wherein the gateway is in communication with a remote system.

In addition to one or more of the features described herein, or as an alternative, further embodiments of the method may include wherein the gateway is in communication with a mobile device.

In addition to one or more of the features described herein, or as an alternative, further embodiments of the method may include wherein the at least one anchor includes a plurality of anchors, each of the plurality of anchors mounted at a different location in the hoistway.

In addition to one or more of the features described herein, or as an alternative, further embodiments of the method may include receiving, at the tag, the reply signal from each of the plurality of anchors; determining, at the tag, the position of the elevator car in response to the reply signal from each of the plurality of anchors.

In addition to one or more of the features described herein, or as an alternative, further embodiments of the method may include the tag eliminating a distance calculation to an anchor of the plurality of anchors in determining the position of the elevator car.

Technical effects of embodiments of the present disclosure include the ability to determine the elevator car position without requiring access to an elevator controller.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 depicts components of an elevator car position detection system in an example embodiment;

FIG. 3 illustrates determining time of flight which allows one to calculate the distance between a tag and an anchor in an example embodiment;

FIG. 4 is a flowchart of a method for determining elevator car position in an example embodiment.

### DETAILED DESCRIPTION

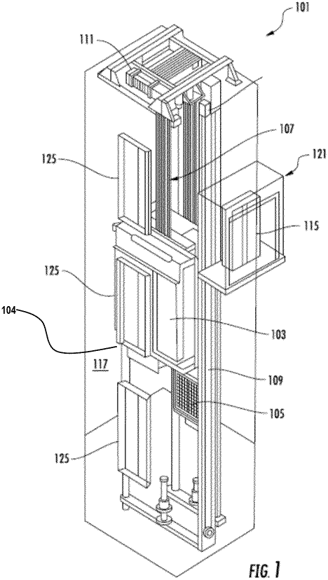

FIG. 1 is a perspective view of an elevator system 101 including an elevator car 103, a counterweight 105, a tension member 107, a guide rail 109, a machine 111 and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an hoistway 117 and along the guide rail 109.

The tension member 107 engages the machine 111, which is part of an overhead structure of the elevator system 101. The machine 111 is configured to control movement between the elevator car 103 and the counterweight 105. The controller 115 is located, as shown, in a controller room 121 of the hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from a position reference system or any other desired position reference device. When moving up or down within the hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within hoistway 117.

The elevator system 101 also includes one or more elevator doors 104. The elevator door 104 may be integrally attached to the elevator car 103 or the elevator door 104 may be located on a landing 125 of the elevator system 101, or both. Embodiments disclosed herein may be applicable to both an elevator door 104 integrally attached to the elevator car 103 or an elevator door 104 located on a landing 125 of the elevator system 101, or both. The elevator door 104 opens to allow passengers to enter and exit the elevator car 103.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

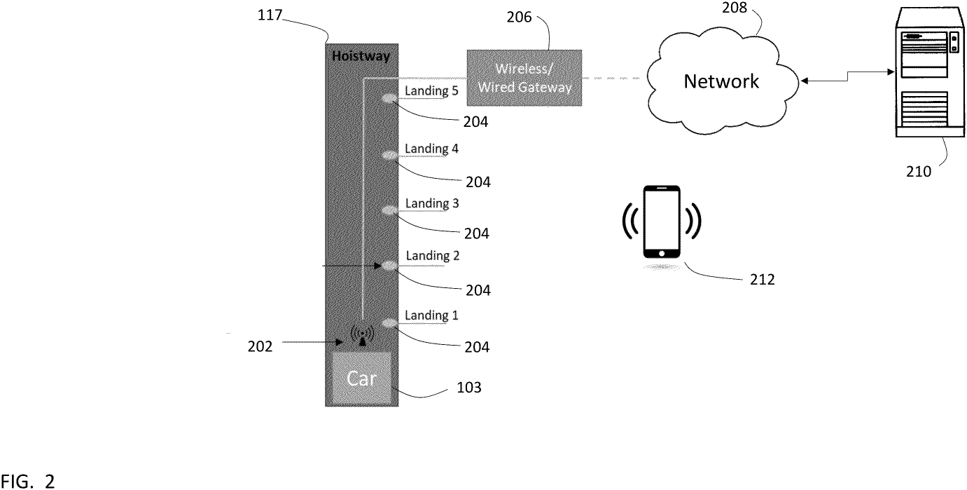

FIG. 2 depicts components of an elevator car position detection system in an example embodiment. A tag 202 is mounted to the elevator car 103. The tag 202 may be an Ultra-Wide Band (UWB) device that emits a wireless poll signal. The tag 202 may be battery powered. One or more anchors 204 are mounted in the hoistway 117. The anchors 204 are in fixed locations, which may correspond to elevators landings. The anchors 204 may be Ultra-Wide Band (UWB) devices that emit a wireless response signal in reply to the poll signal from the tag 202. Although five anchors 204 are shown in FIG. 2, any number of anchors may be used. In an example embodiment, a single anchor 204 may be used (e.g., positioned at the top of the hoistway 117).

A gateway 206 is in communication with the tag 202. The gateway 206 may be a wireless access point configured to communicate with the tag 202 using one or more wireless communication protocols (e.g., 802.xx, radio, cellular, etc.). Data from the tag 202 is communicated to the gateway 206 periodically. In other embodiments, the tag 202 communicates with the gateway by a wired connection (e.g., a traveling cable).

The gateway 206 communicates with a remote system 210 over a network 208. The network 208 may be implemented via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), or any broadband network, and further enabled with technologies such as, by way of example, Global System for Mobile Communications (GSM), Personal Communications Service (PCS), Bluetooth, WiFi, Fixed Wireless Data, 2G, 2.5G, 3G (e.g., WCDMA/UMTS based 3G networks), 4G, 5G, IMT-Advanced, pre-4G, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, HSPA+, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks, broadband networks, or messaging protocols.

The remote system 210 may be embodied as any type of processor-based computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system (e.g., cloud computing), a processor-based system, and/or a consumer electronic device.

A mobile device 212 may be used to communicate with the gateway 206 and/or the remote system 210. The mobile device 212 may be a processor equipped device such as a mobile phone, a tablet, a laptop computer, etc., equipped with a communication module compatible with communication protocols used by the gateway 206 and/or the remote system 210.

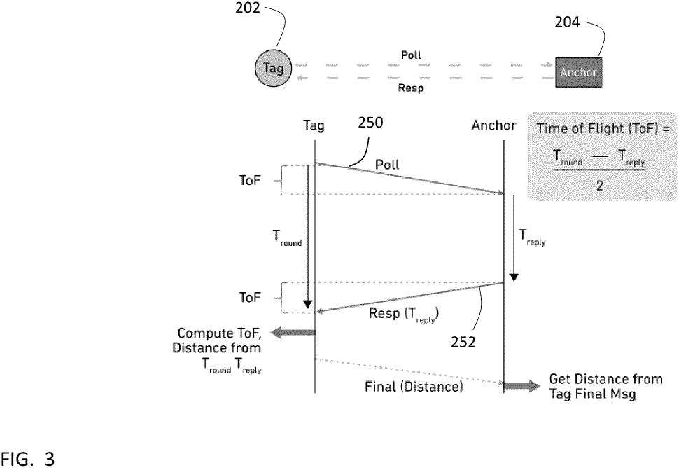

FIG. 3 illustrates determining distance between a tag 202 and an anchor 204 in an example embodiment. The tag 202 periodically transmits a wireless poll signal 250. Upon receipt of the poll signal, the anchor 204 generates a wireless reply signal 252. The anchor 204 requires a time, Treply to generate the reply signal 252. The reply signal 252 is then received at the tag 202. The total time between sending the poll signal from the tag 202 to receiving the reply signal at the tag 202 is Tround. By using Tround and Treply, the distance between the tag 202 and the anchor 204 is determined as ((Tround-Treply)/2), which is the time of flight between the tag 202 and the anchor 204, times the speed of light. As the anchors 204 are in fixed, known locations, the location of the tag 202, and hence the elevator car 103, is determined by computing the distance between the tag 202 and one or more anchors 204.

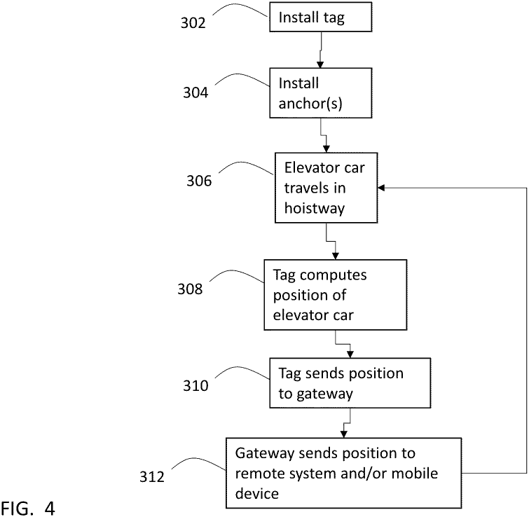

FIG. 4 is a flowchart of a method for determining elevator car position in an example embodiment. The process begins at 302 where the tag 202 is installed on the elevator car 103, for example on the top of the elevator car 103. At 304, one or more anchors 204 are installed in the hoistway 117. The anchors 204 may also be associated with a known location, for example a landing number or height in the hoistway 117.

At 306, the elevator car 103 travels in the hoistway 117. At 308, as the elevator car 103 travels, the tag 202 sends the poll signal 250, receives the reply signal 252, and determines position of the elevator car 103. The reply signal 252 may include a known location of the anchor 204, and the tag 202 determines the elevator car position relative to the known location of the anchor 204. In some embodiments, an angle of the reply signal 252 as determined at the tag 202 is used to determine the elevator car position.

If multiple anchors 204 are used, the tag 202 may use filtering and/or modeling processes to eliminate distance calculations that appear inaccurate. In one example, if the distance to two anchors 204 appears in conflict, then the distance to the closer anchor 204 is used, on the assumption this distance is more accurate. Preference may also be given to an anchor 204 that has line-of-sight communication to the tag 202 over an anchor 204 that does not because of the location of the car 103.

At 310, the tag 202 sends the current elevator car position to the gateway 206. This may occur periodically (e.g., once every second). In one embodiment, this may occur continuously. At 312, the gateway 206 then forwards the elevator car position to the remote system 210 and/or mobile device 212. In other embodiments, the tag 202 sends the current elevator car position directly to the mobile device 212. The process then returns to 306 for continuous monitoring of elevator car position.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator car position determining system comprising:
a tag mounted to an elevator car, the elevator car configured to travel in a hoistway;
at least one anchor mounted in the hoistway;
a gateway in communication with the tag;
wherein the tag is configured to send a poll signal;
wherein the at least one anchor is configured to generate a reply signal in response to the poll signal;
wherein the tag is configured to determine a position of the elevator car in the hoistway in response to a time of flight of the poll signal to the at least one anchor and a time of flight of the reply signal to the tag.

2. The elevator car position determining system of claim 1, wherein the tag is configured to send the position of the elevator car to the gateway.

3. The elevator car position determining system of claim 1, wherein the tag is configured to send the position of the elevator car to a mobile device.

4. The elevator car position determining system of claim 1, wherein the gateway is in communication with a remote system.

5. The elevator car position determining system of claim 1, wherein the gateway is in communication with a mobile device.

6. The elevator car position determining system of claim 1, wherein the at least one anchor includes a plurality of anchors, each of the plurality of anchors mounted at a different location in the hoistway.

7. The elevator car position determining system of claim 6, wherein the tag is configured to receive the reply signal from each of the plurality of anchors;
wherein the tag is configured to determine the position of the elevator car in response to the reply signal from each of the plurality of anchors.

8. The elevator car position determining system of claim 7, wherein the tag is configured to eliminate a distance calculation to an anchor of the plurality of anchors in determining the position of the elevator car.

9. A method of determining a position of an elevator car, the method comprising:
installing a tag on an elevator car, the elevator car configured to travel in a hoistway;
installing at least one anchor in the hoistway;
installing a gateway, the gateway in communication with the tag;
sending a poll signal from the tag;
generating a reply signal at the anchor in response to the poll signal;
determining, by the tag, the position of the elevator car in the hoistway in response to a time of flight of the poll signal to the at least one anchor and a time of flight of the reply signal to the tag.

10. The method of claim 9, further comprising sending the position of the elevator car to the gateway.

11. The method of claim 9, further comprising sending the position of the elevator car to a mobile device.

12. The method of claim 9, wherein the gateway is in communication with a remote system.

13. The method of claim 9, wherein the gateway is in communication with a mobile device.

14. The method of claim 9, wherein the at least one anchor includes a plurality of anchors, each of the plurality of anchors mounted at a different location in the hoistway.

15. The method of claim 14, further comprising:
receiving, at the tag, the reply signal from each of the plurality of anchors;
determining, at the tag, the position of the elevator car in response to the reply signal from each of the plurality of anchors.

16. The method of claim 15, further comprising the tag eliminating a distance calculation to an anchor of the plurality of anchors in determining the position of the elevator car.
